(19) United States
(12) Patent Application Publication
(10) Pub. No.: US 2026/0212813 A1
(43) Pub. Date: Jul. 23, 2026

(54) AMBIENT LIGHT ADAPTIVE PIXEL ANTI-AGING FRAME-LAYER CONDITIONAL COMPENSATION

(71) Applicant: QUALCOMM Incorporated, San Diego, CA (US)

(72) Inventors: Nan ZHANG, Beijing (CN); Xinchao YANG, Shanghai (CN); Yongjun XU, Beijing (CN)

(21) Appl. No.: 19/140,322

(22) PCT Filed: Feb. 16, 2023
(86) PCT No.: PCT/CN2023/076356

§ 371 Date: Jun. 17, 2025

(51) Int. Cl. G09G 3/3208

(52) U.S. Cl. CPC G09G 3/3208; G09G 2320/046; G09G 2360/144; G09G 2360/16

(57) ABSTRACT

This disclosure provides systems, devices, apparatus, and methods, including computer programs encoded on storage media, for ambient light adaptive pixel anti-aging frame-layer conditional compensation. A processor may monitor an intensity value of ambient light associated with a display device, where the display device includes a display panel associated with a set of pixels. The processor may perform a comparison between the intensity value of the ambient light associated with the display device and an ambient light threshold. The processor may calculate, based on the comparison and a luminance level for the set of pixels, an adjustment level of an anti-aging attenuation factor for each of the set of pixels. The processor may output an indication of the calculated adjustment level for the anti-aging attenuation factor associated with the set of pixels.

### TECHNICAL FIELD

The present disclosure relates generally to processing systems, and more particularly, to one or more techniques for display processing.

### Introduction

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Pixels in a display panel may decay over time. Current techniques pertaining to pixel decay may boost a luminance of decayed pixels or attenuate other pixels to match the luminance of the decayed pixels. There is a need for improved techniques pertaining to anti-aging for pixels in a display panel.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and at least one processor coupled to the memory and, based at least in part on information stored in the memory, the at least one processor is configured to: monitor an intensity value of ambient light associated with a display device, where the display device includes a display panel associated with a set of pixels; perform a comparison between the intensity value of the ambient light associated with the display device and an ambient light threshold; calculate, based on the comparison and a luminance level for the set of pixels, an adjustment level of an anti-aging attenuation factor for each of the set of pixels; and output an indication of the calculated adjustment level for the anti-aging attenuation factor associated with the set of pixels.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating examples of compensating for decayed pixels in accordance with one or more techniques of this disclosure.

FIG. 5 is a diagram illustrating an example of computing an adjustment level of an anti-aging attenuation factor based on an ambient light intensity level in accordance with one or more techniques of this disclosure.

FIG. 6 is a diagram illustrating example mapping strategies for ambient light intensity values to adjustment levels of anti-aging attenuation factors in accordance with one or more techniques of this disclosure.

FIG. 7 is a diagram illustrating an example of applying an adjustment level of an anti-aging attenuation factor to pixels in accordance with one or more techniques of this disclosure.

FIG. 8 is a diagram illustrating further example mapping strategies for ambient light intensity values to adjustment levels of anti-aging attenuation factors in accordance with one or more techniques of this disclosure.

FIG. 9 is a call flow diagram illustrating example communications between a central processing unit (CPU) and a display processing unit (DPU) in accordance with one or more techniques of this disclosure.

FIG. 10 is a flowchart of an example method of graphics processing in accordance with one or more techniques of this disclosure.

FIG. 11 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Pixels (or subpixels) on a display panel (e.g., an organic light-emitting diode (OLED display panel) may decay such that the decayed pixels (or decayed subpixels) are no longer capable of reaching their respective maximum luminance and instead can reach a luminance that is less than a maximum luminance. For instance, a device may be configured with a value (e.g., a value ranging from 0-255) that is intended to produce a first luminance for a pixel, but due to decay, the value may produce a second luminance for the pixel, where the second luminance for the pixel is less than the first luminance. In an example, pixels (or subpixels) may decay due to an age of the display panel, wear and tear of the display panel, and/or “burn-in” caused by the same or similar content being repeatedly displayed in a region of the display panel. Decayed pixels (or decayed subpixels) may affect a user experience with content displayed on the display panel, as the content may not be displayed at an intended luminance due to the decayed pixels (or decayed subpixels).

Some techniques address decayed pixels (or subpixels) by increasing (i.e., boosting) a value associated with a decayed pixel to increase a luminance of the decayed pixel to compensate for the decay. For instance, if a first value (e.g., 100) is intended to produce a first luminance in a pixel, but due to pixel decay, the first value would produce a second luminance in the pixel that is less than the first luminance, a device may increase the first value to a second value (e.g., 105) that, in the absence of pixel decay, would cause the pixel to produce a third luminance greater than the first luminance and the second luminance; however, due to pixel decay, the second value causes the pixel to produce the first luminance. Such techniques may not be suitable for white content images and/or bright content images, as values associated with pixels may not be increased beyond a certain value (e.g., 255). Other techniques address decayed pixels (or subpixels) by attenuating (i.e., reducing) luminance of other (non-decayed) pixels on the display panel to match a luminance of the decayed pixels or subpixels. However, such techniques may cause an overall luminance of the display panel to be reduced, as luminance of each pixel may be reduced to match the decayed pixels (or decayed subpixels).

Various technologies pertaining to ambient light adaptive pixel anti-aging frame-layer conditional compensation are described herein. In an example, an apparatus (e.g., a CPU) monitors an intensity value of ambient light associated with a display device, where the display device includes a display panel associated with a set of pixels. The intensity value of the ambient light may be an illuminance measurement in lux. The apparatus performs a comparison between the intensity value of the ambient light associated with the display device and an ambient light threshold. The apparatus calculates, based on the comparison and a luminance level for the set of pixels, an adjustment level of an anti-aging attenuation factor for each of the set of pixels. The apparatus outputs an indication of the calculated adjustment level for the anti-aging attenuation factor associated with the set of pixels. Vis-à-vis the calculation of the adjustment level of the anti-aging factor (which is based on an intensity value of ambient light), the aforementioned technologies may mitigate pixel decay by attenuating luminance in scenarios in which pixel decay is noticeable by a user, such as indoor usage scenarios, and not attenuating luminance (or utilizing limited attenuation) in scenarios in which pixel decay is not noticeable by a user, such as outdoor usage scenarios. Furthermore, the above-described technologies may be readily implemented in a variety of devices, such as smart phones, tablet computing devices, etc.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

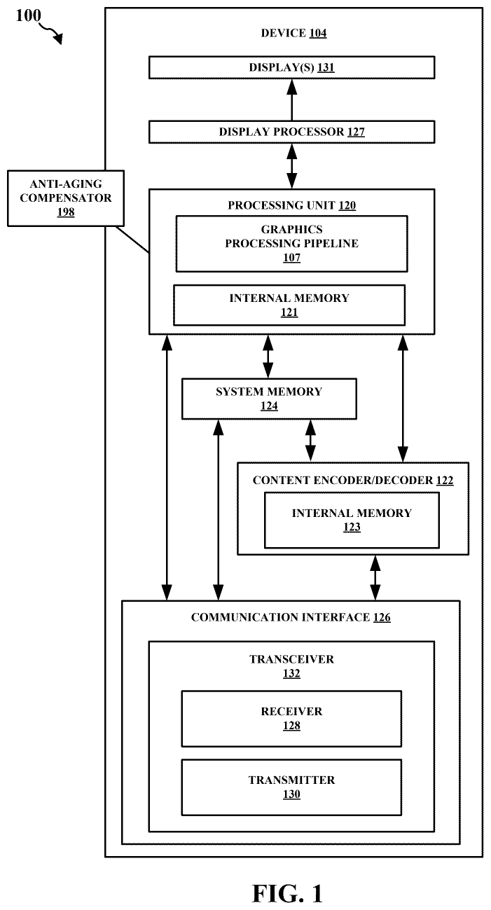

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an anti-aging compensator 198 configured to monitor an intensity value of ambient light associated with a display device, where the display device includes a display panel associated with a set of pixels; perform a comparison between the intensity value of the ambient light associated with the display device and an ambient light threshold; calculate, based on the comparison and a luminance level for the set of pixels, an adjustment level of an anti-aging attenuation factor for each of the set of pixels; output an indication of the calculated adjustment level for the anti-aging attenuation factor associated with the set of pixels. Although the following description may be focused on display processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

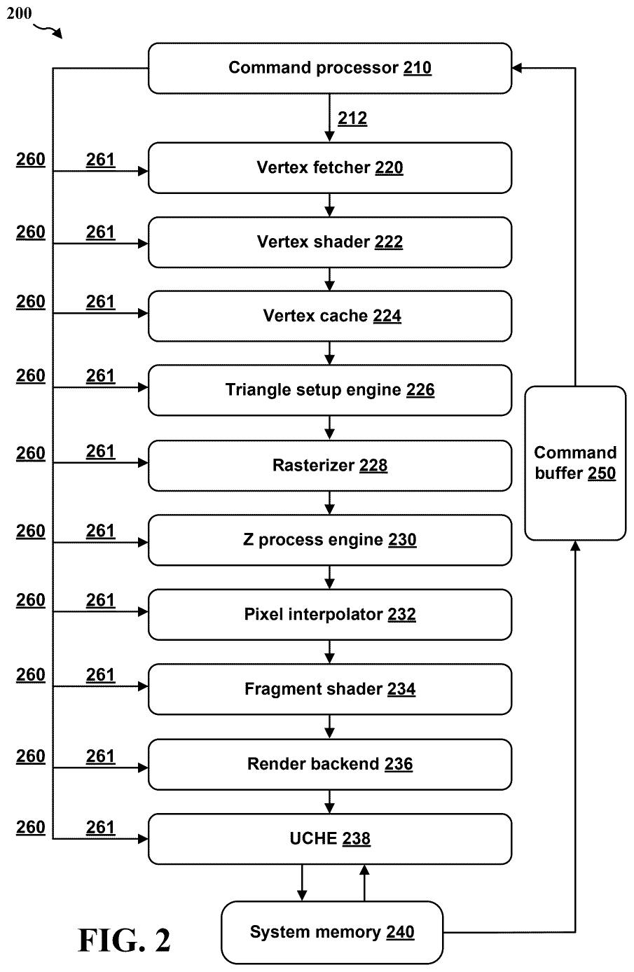

FIG. 2 illustrates an example GPU 200 in accordance with one or more techniques of this disclosure. As shown in FIG. 2, GPU 200 includes command processor (CP) 210, call data packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call data packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

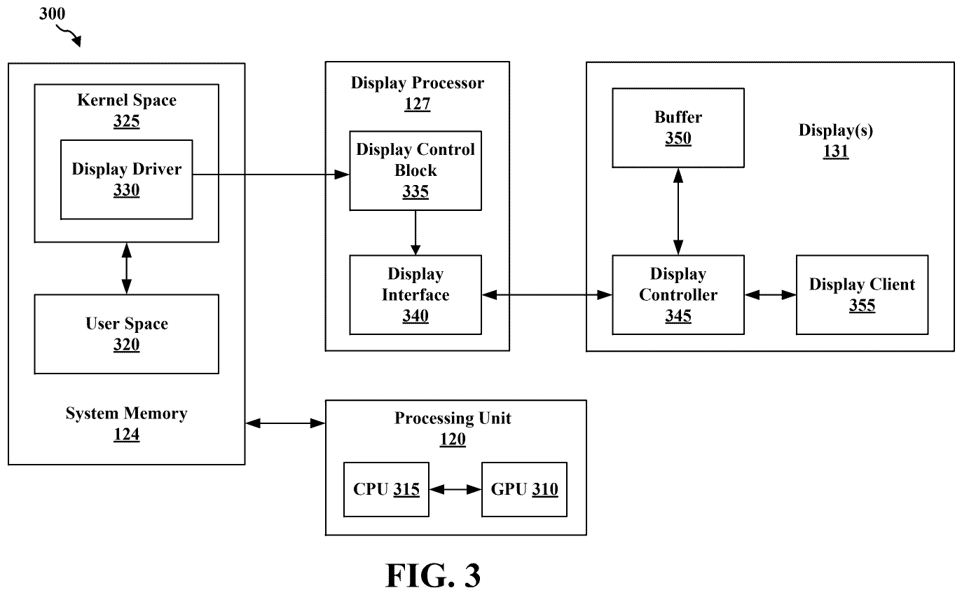

FIG. 3 is a block diagram 300 that illustrates an example display framework including the processing unit 120, the system memory 124, the display processor 127, and the display(s) 131, as may be identified in connection with the device 104.

A graphics processor (e.g., a GPU) may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

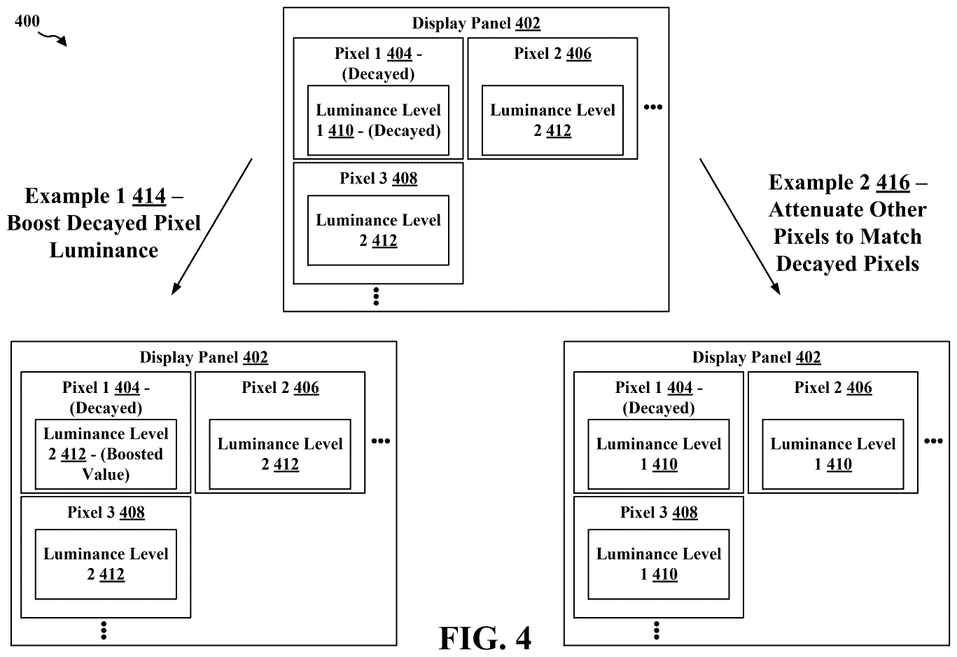

FIG. 4 is a diagram 400 illustrating examples of compensating for decayed pixels in accordance with one or more techniques of this disclosure. As noted above, pixels (or subpixels) on a display panel (e.g., an organic light-emitting diode (OLED display panel) may decay such that the decayed pixels (or decayed subpixels) are no longer capable of reaching their respective maximum luminance and instead can reach a luminance that is less than a maximum luminance. As used herein, luminance may refer to a photometric measure of a luminous intensity per unit area of light travelling in a given direction. A device may be configured with a value (e.g., a value ranging from 0-255) that is intended to produce a first luminance for a pixel, but due to decay, the value may produce a second luminance for the pixel, where the second luminance for the pixel is less than the first luminance. In an example, pixels (or subpixels) may decay due to an age of the display panel, wear and tear of the display panel, and/or “burn-in” caused by the same or similar content being repeatedly displayed in a region of the display panel. Decayed pixels (or decayed subpixels) may affect a user experience with content displayed on the display panel, as the content may not be displayed at an intended luminance due to the decayed pixels (or decayed subpixels).

The diagram 400 depicts a display panel 402 that includes a first pixel 404, a second pixel 406, and a third pixel 408 (as well as other pixels not illustrated in FIG. 4.). The display panel 402 may be included in the device 104 (i.e., the display panel 402 may be or include the display(s) 131 of the device 104). In an example, the display panel 402 may be an OLED display panel. The first pixel 404 may be a decayed pixel, and as such, the first pixel 404 may have a first luminance level 410 due to the decay. The second pixel 406 and the third pixel 408 may have a second luminance level 412 that is greater than the first luminance level 410. For instance, the first pixel 404, the second pixel 406, and the third pixel 408 may each be configured with a first value that is intended to produce the second luminance level 412, but due to decay of the first pixel 404, the first pixel 404 produces the first luminance level 410 instead of the second luminance level 412. For example, the first luminance level 410 may be 1500 nits and the second luminance level 412 may be 2000 nits.

In a first example 414, a device may boost decayed pixel luminance in order to compensate for the decay of the first pixel 404. For instance, the device may configure the first pixel 404 with a second value that is greater than the first value. For a non-decayed pixel, the second value may produce a third luminance level that is greater than the first luminance level 410 and the second luminance level 412; however, as the first pixel 404 is decayed, the second value may cause the first pixel 404 to produce the second luminance level 412. The boosting depicted in the first example 414 may not be suitable for white content images and/or bright content images displayed on the display panel 402, as values associated with pixels may not be increased beyond a certain value (e.g., 255).

In a second example 416, the device may attenuate luminance levels of non-decayed pixels in order to match the (decayed) first pixel 404. For instance, the device may configure the second pixel 406 and the third pixel 408 with a value that is less than the first value that causes the second pixel 406 and the third pixel 408 to produce the first luminance level 410. The attenuation depicted in the second example 416 may cause an overall luminance of the display panel 402 to be reduced, as luminance levels of the second pixel 406 and the third pixel 408 are reduced to match the first luminance level 410 of the (decayed) first pixel 404. Such attenuation may affect user experience, as the display panel 402 may not be perceived by the user to be as bright as the user expects. Furthermore, depending on an extent of the decay of the first pixel 404, the luminance levels of the second pixel 406 and the third pixel 408 may be greatly decreased. Stated differently, a frame/layer pixel maximum luminance attenuation/reduction may be determined by a pixel that has decayed the most. As the decay increases, the frame/layer pixel maximum luminance may decrease.

Compensating for decayed pixels (such as in the first example 414 and the second example 416) may be referred to as anti-aging. Anti-aging may be a trade-off between maximum luminance loss and decayed pixel visual loss. Some anti-aging techniques may apply the same attenuation ratio for the same device regardless of ambient light around the device. For instance, the same maximum luminance loss and decayed pixel visual loss trade-off policy may be applied to the same device. In an example, a device may apply the same attenuation ratio regardless of whether the device is located indoors or outdoors without taking into account visual perception of a user of the device.

In one example, maximum brightness may be more relevant to a user when a device is located outdoors, as light sources such as the Sun may affect an ability of the user to view content on the device, and decayed pixel visual loss may be less relevant to the user. In another example, decayed pixel visual loss may be more relevant to a user when the device is located indoors (e.g., in a dark room or a room with an ambient light level that is below an ambient light threshold), and maximum brightness may be less relevant to the user.

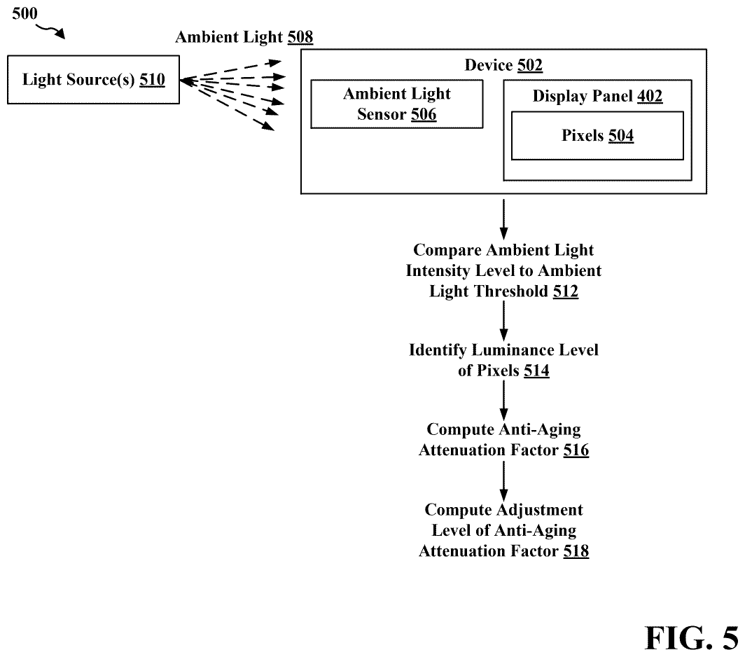

FIG. 5 is a diagram 500 illustrating an example of computing an adjustment level of an anti-aging attenuation factor based on an ambient light intensity level in accordance with one or more techniques of this disclosure. As noted above, the boosting and the attenuation described in the first example 414 and the second example 416 may not account for user experience when viewing content on a display panel with decayed pixels (or decayed subpixels).

The diagram 500 depicts a device 502. The device may be or include the device 104. In an example, the device 502 may be a mobile phone, a tablet computing device, a desktop computing device, a laptop computing device, etc. The device 502 may include the display panel 402. The display panel 402 may include pixels 504. The pixels 504 may be or include the (decayed) first pixel 404, the second pixel 406, and the third pixel 408 as described above in the description of FIG. 4.

The device 502 may include an ambient light sensor 506. The ambient light sensor 506 may be a photodetector that is used to sense an amount of ambient light present around the ambient light sensor 506. The device 502 may be configured to measure an intensity level of ambient light 508 around the device 502. In an example, the intensity level of the ambient light 508 may be a luminance level. The ambient light 508 may originate from light source(s) 510. The light source(s) 510 may be or include the Sun, indoor lighting, outdoor lighting, etc.

The device 502 may be configured to monitor the intensity level of the ambient light 508 and to map the intensity level of the ambient light 508 to an anti-aging attenuation strength (i.e., an adjustment level for an anti-aging attenuation factor). The device may apply the anti-aging attenuation strength to the pixels 504 in order to compensate for pixel decay. For instance, at 512, the device 502 may compare the intensity level of the ambient light 508 to an ambient light threshold level. In an example, the ambient light threshold level may an illuminance value (e.g., in lux). In an example, the ambient light threshold level may be 100,000 lux, 10,000 lux, 1,000, lux, 100 lux, 10 lux, 1 lux, 0.1 lux, 0.01 lux, 0.001 lux, or 0.0001 lux. At 514, the device 502 may identify a luminance level of the pixels 504. At 516, the device 502 may compute an anti-aging attenuation factor. At 518, the device 502 may compute an adjustment level of the anti-aging attenuation factor. The aforementioned aspects will be discussed in greater detail below.

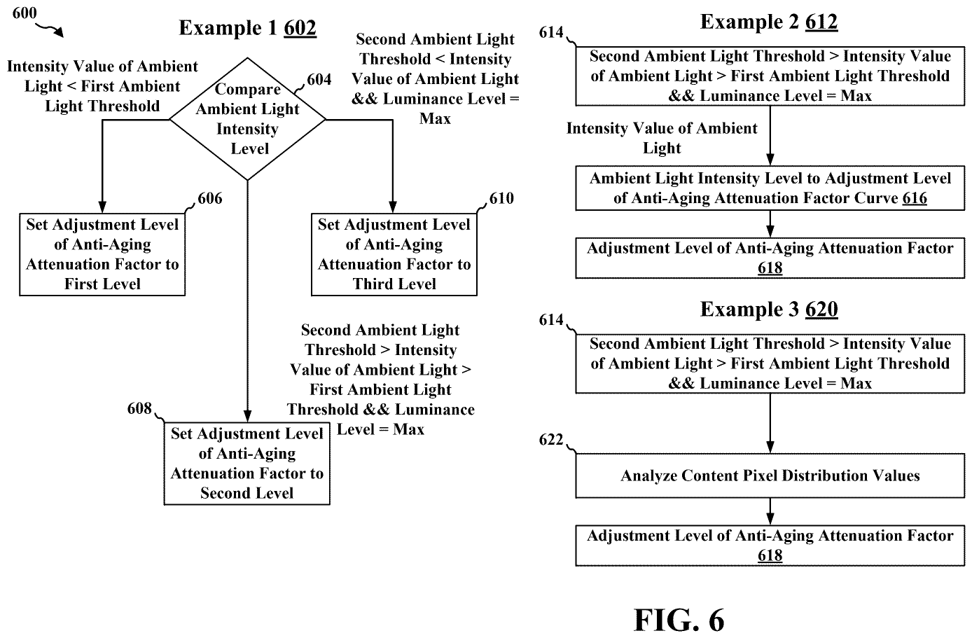

FIG. 6 is a diagram 600 illustrating example mapping strategies for ambient light intensity values to adjustment levels of anti-aging attenuation factors in accordance with one or more techniques of this disclosure. As discussed above in connection with FIG. 5, a device may be configured to monitor (i.e., measure or detect) an intensity level of ambient light and to map the intensity level of the ambient light to an anti-aging attenuation strength (i.e., an adjustment level for an anti-aging attenuation factor).

In a first example 602, at 604, a device (e.g., the device 502) may compare an intensity level of ambient light (e.g., as measured via the ambient light sensor 506) to at least one of a first ambient light threshold or a second ambient light threshold, where the second ambient light threshold is greater than the first ambient light threshold. The first ambient light threshold and the second ambient light threshold may be luminance levels. Additionally, at 604, the device may also identify a luminance level of pixels (e.g., the pixels 504) on a display panel (e.g., the display panel 402) and compare the luminance level to a maximum luminance level.

At 606, if the intensity value of the ambient light is less than the first ambient light threshold, the device may set an adjustment level of an anti-aging attenuation factor to a first level. For example, if the intensity value of the ambient light is less than the first ambient light threshold, the device may be located in an indoor area or in a dark room. As such, a maximum luminance of a display panel (e.g., the display panel 402) of the device may be less relevant from a user experience perspective in comparison to other usage scenarios. Thus, the first level may correspond to an anti-aging attenuation strength of 100% (or an anti-aging attenuation strength of approximately 100%, such as 90% to 100%).

At 608, if the intensity value of the ambient light is greater than the first ambient light threshold and less than the second ambient light threshold and a luminance level of pixels on the display panel is at a maximum luminance, the device may set the adjustment level of the anti-aging attenuation factor to a second level that is less than the first level. For example, if the intensity value of the ambient light is greater than the first ambient light threshold and less than the second ambient light threshold, the device may be located outdoors in a dark environment. As such, the maximum luminance of the display panel and decayed pixel visual loss may both be relevant from a user experience perspective. Thus, the second level may correspond to an anti-aging attenuation strength of 50%-60%. The second level may be a pre-tuned value.

At 610, if the intensity value of the ambient light is greater than the second ambient light threshold and the luminance level of pixels on the display panel is at a maximum luminance, the device may set the adjustment level of the anti-aging attenuation factor to a third level that is less than the second level. For example, if the intensity value of the ambient light is greater than the second ambient light threshold and the luminance level of pixels on the display panel is at a maximum luminance, the device may be located outdoors in a light environment (e.g., in sunshine). As such, the maximum luminance of the display panel may be more relevant from a user experience perspective in comparison to other usage scenarios. Thus, the third level may correspond to an anti-aging attenuation strength of 0% (or an anti-aging attenuation strength of approximately 0%, such as 0% to 10%).

In a second example 612, at 614, the device may determine that the intensity value of the ambient light is greater than the first ambient light threshold and less than the second ambient light threshold and a luminance level of pixels on the display panel is at a maximum luminance. The device may access an ambient light intensity level to adjustment level of anti-aging attenuation factor curve 616 (e.g., a pre-tuned curve) stored in memory of the device. The device may determine an adjustment level of an anti-aging attenuation factor 618 based on the intensity value of the ambient light and the ambient light intensity level to adjustment level of anti-aging attenuation factor curve 616.

In a third example 620, at 614, the device may determine that the intensity value of the ambient light is greater than the first ambient light threshold and less than the second ambient light threshold and a luminance level of pixels on the display panel is at a maximum luminance. At 622, the device may analyze a distribution of pixel values for content that is being displayed or will be displayed on the display panel. The device may determine the adjustment level of the anti-aging attenuation factor 618 based on the distribution.

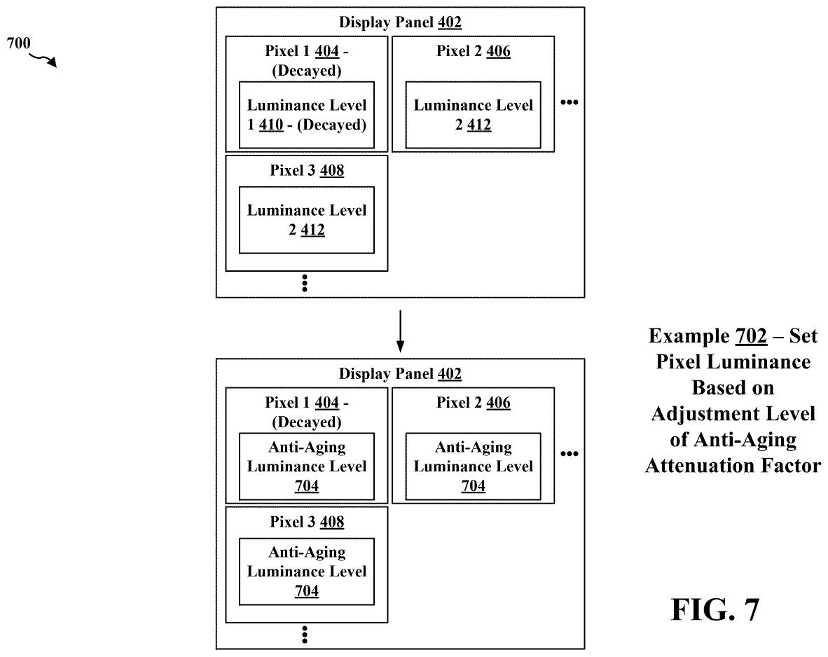

FIG. 7 is a diagram 700 illustrating an example 702 of applying an adjustment level of an anti-aging attenuation factor to pixels in accordance with one or more techniques of this disclosure. The adjustment level of the anti-aging attenuation factor may be determined/computed as discussed above in the description of FIGS. 5 and 6 above. A device may apply the adjustment level of the anti-aging attenuation factor to the first pixel 404, the second pixel 406, and the third pixel 408 such that the first pixel 404, the second pixel 406, and the third pixel 408 have an anti-aging luminance level 704.

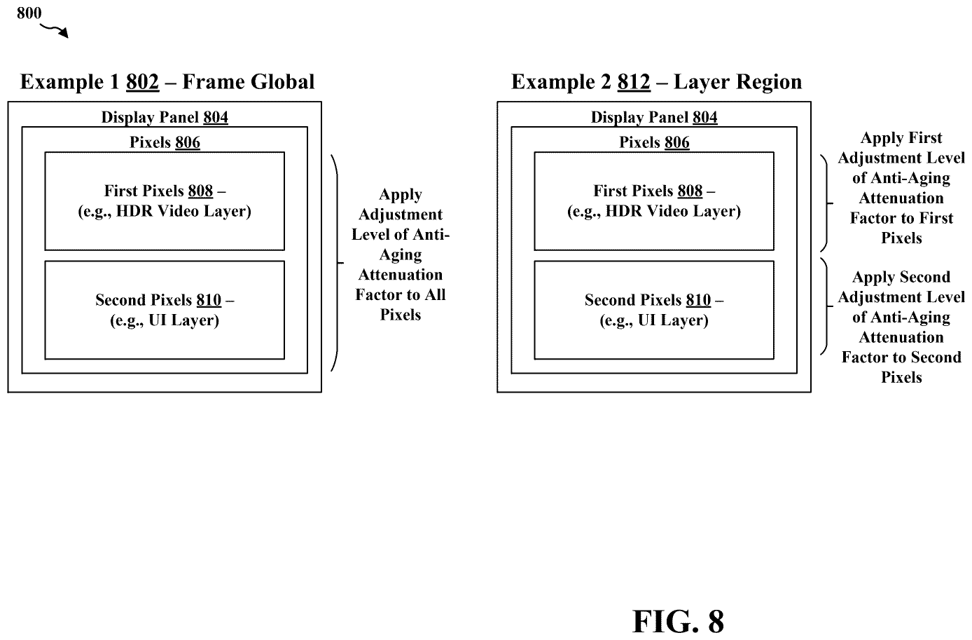

FIG. 8 is a diagram 800 illustrating further example mapping strategies for ambient light intensity values to adjustment levels of anti-aging attenuation factors in accordance with one or more techniques of this disclosure. As discussed above, a device may determine/compute an adjustment level of an anti-aging attenuation factor as described above in the description of FIGS. 5 and 6.

In a first example 802, a device may apply the adjustment level of the anti-aging attenuation factor to all pixels (i.e., “frame global” or “global strategy”). For instance, a display panel 804 may include pixels 806. In an example, the display panel may be or include the display panel 402. The pixels 806 may include first pixels 808 and second pixels 810, where one or more pixels in the first pixels 808 and/or the second pixels 810 may be decayed pixels. In an example, the first pixels 808 may correspond to a high dynamic range (HDR) video layer and the second pixels 810 may correspond to a user interface (UI) layer displayed on the display panel 804. In another example, the first pixels 808 may correspond to a video being shown on the display panel 804 and the second pixels 810 may correspond to UI elements (e.g., play, pause, rewind, etc.) associated with a video player playing the video. The device may apply the adjustment level of the anti-aging attenuation factor to the first pixels 808 and the second pixels 810.

In a second example 812, the device may compute/determine a first adjustment level of the anti-aging attenuation factor and a second adjustment level of the anti-aging attenuation factor as described above in the description of FIGS. 5 and 6, where the first adjustment level of the anti-aging attenuation factor may correspond to the first pixels 808 and where the second adjustment level of the anti-aging attenuation factor may correspond to the second pixels 810. The device may apply the first adjustment level of the anti-aging attenuation factor to the first pixels 808 and the second adjustment level of the anti-aging attenuation factor to the second pixels 810 (i.e., layer-based strategy). In one example, the first adjustment level of the anti-aging attenuation factor may be 0% (or near 0%, such as 0%-10%), as the first pixels 808 may display HDR video. In another example, the second pixels 810 may display a white and/or a relatively bright UI element and as such, the second adjustment level of the anti-aging attenuation factor may be non-zero. In yet another example, the second pixels 810 may display a dark UI element and as such, the second adjustment level of the anti-aging attenuation factor may be weak and/or nominal.

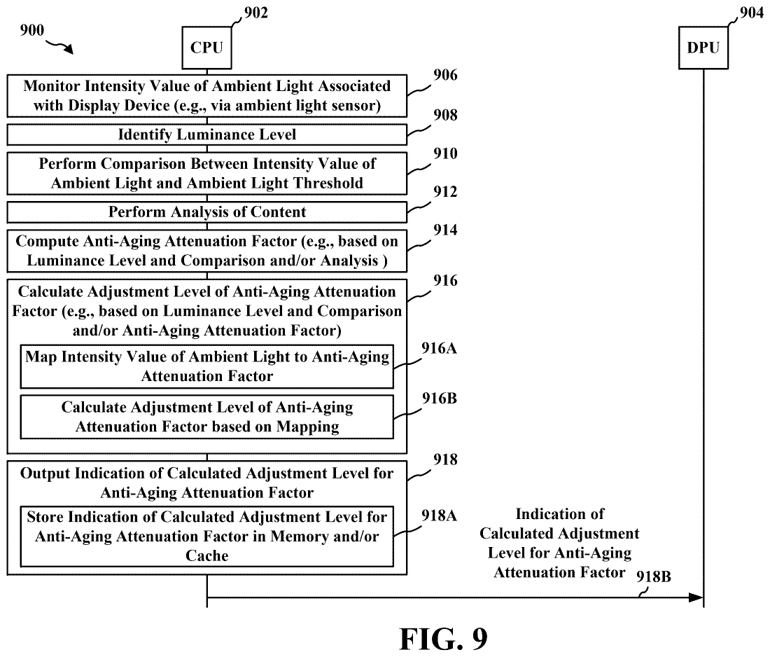

FIG. 9 is a call flow diagram 900 illustrating example communications between a central processing unit (CPU) 902 and a display processing unit (DPU) 904 in accordance with one or more techniques of this disclosure. In an example, the CPU 902 may be or include the processing unit 120 and the DPU 904 may be or include the display processor 127.

At 906, the CPU 902 may monitor (e.g., via an ambient light sensor) an intensity value of ambient light associated with a display device including a display panel associated with a set of pixels. At 908, the CPU 902 may identify a luminance level of the set of pixels. At 910, the CPU 902 may perform a comparison between an intensity value of the ambient light and an ambient light threshold. At 912, the CPU 902 may perform an analysis of content for the set of pixels associated with the display panel of the display device. For example, the CPU 902 may determine a distribution of pixel values of the content. In an example, the distribution of pixel values of the content may be for a currently displayed frame of the content and/or a to-be-displayed frame of the content. At 914, the CPU 902 may compute an anti-aging attenuation factor for the set of pixels based on the comparison and the luminance level (and the analysis). At 916, the CPU 902 may calculate an adjustment level of an anti-aging attenuation factor for each of the set of pixels based on the comparison and a luminance level for the set of pixels (and the anti-aging attenuation factor). For instance, at 916A, the CPU 902 may map the intensity value of the ambient light to the anti-aging attenuation factor for each of the set of pixels. For instance, at 916B, the CPU 902 may calculate, based on the mapping, the adjustment level of the anti-aging attenuation factor for each of the set of pixels. At 918, the CPU 902 may output an indication of the calculated adjustment level for the anti-aging attenuation factor associated with the set of pixels. For instance, at 918A, the CPU 902 may store, in a memory or a cache (e.g., a memory or cache at a CPU or DPU), the indication of the calculated adjustment level for the anti-aging attenuation factor associated with the set of pixels. For instance, at 918B, the CPU 902 may transmit, to the DPU 904, the indication of the calculated adjustment level for the anti-aging attenuation factor associated with the set of pixels. The DPU 904 may apply the calculated adjustment level for the anti-aging attenuation factor such that the set of pixels has a desired luminance that compensates for decayed pixels.

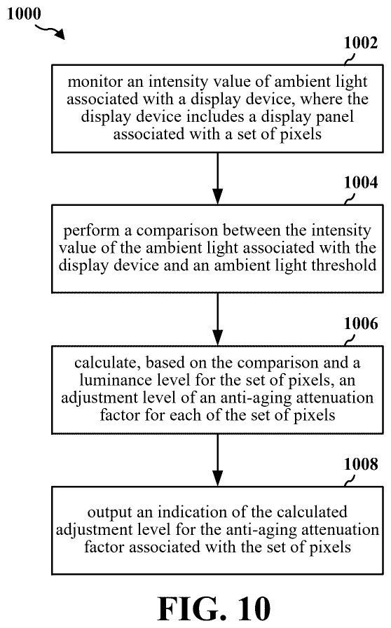

FIG. 10 is a flowchart 1000 of an example method of display processing in accordance with one or more techniques of this disclosure. The method may be performed by an apparatus, such as an apparatus for display processing, a GPU, a CPU, a wireless communication device, and the like, as used in connection with the aspects of FIGS. 1-9. In an example, the apparatus may be or include the device 104, the processing unit 120, the device 502, and/or the CPU 902. In an example, the method may be performed by the anti-aging compensator 198.

At 1002, the apparatus (e.g., a CPU) monitors an intensity value of ambient light associated with a display device, where the display device includes a display panel associated with a set of pixels. For example, FIG. 9 at 906 shows that the CPU 902 may monitor an intensity value of ambient light associated with a display device. In an example, the display device may be or include the device 104 and/or the device 502, the display panel may be or include the display(s) 131, the display panel 402, and/or the display panel 804, and the set of pixels may be or include the first pixel 404, the second pixel 406, the third pixel 408, the pixels 504, and/or the pixels 806. In another example, monitoring the intensity value of the ambient light may include aspects described above in connection with FIG. 5. In an example, 1002 may be performed by the anti-aging compensator 198.

At 1004, the apparatus (e.g., a CPU) performs a comparison between the intensity value of the ambient light associated with the display device and an ambient light threshold. For example, FIG. 9 at 910 shows that the CPU 902 may perform a comparison between the intensity value of the ambient light and an ambient light threshold. In an example, performing the comparison may include aspects described above in connection with FIG. 5 and/or the first example 602 of FIG. 6. In an example, 1004 may be performed by the anti-aging compensator 198.

At 1006, the apparatus (e.g., a CPU) calculates, based on the comparison and a luminance level for the set of pixels, an adjustment level of an anti-aging attenuation factor for each of the set of pixels. For example, FIG. 9 at 916 shows that the CPU 902 may compute an adjustment level of an anti-aging attenuation factor for a set of pixels based on the comparison performed at 910 and a luminance level for the set of pixels. In an example, calculating the adjustment level of the anti-aging attenuation factor for each of the set of pixels may include aspects described above in connection with FIGS. 5 and 6. In an example, 1006 may be performed by the anti-aging compensator 198.

At 1008, the apparatus (e.g., a CPU) outputs an indication of the calculated adjustment level for the anti-aging attenuation factor associated with the set of pixels. For example, FIG. 9 at 918 shows that the CPU 902 may output an indication of the calculated adjustment level for the anti-aging attenuation factor associated with the set of pixels. In an example, 1008 may be performed by the anti-aging compensator 198.

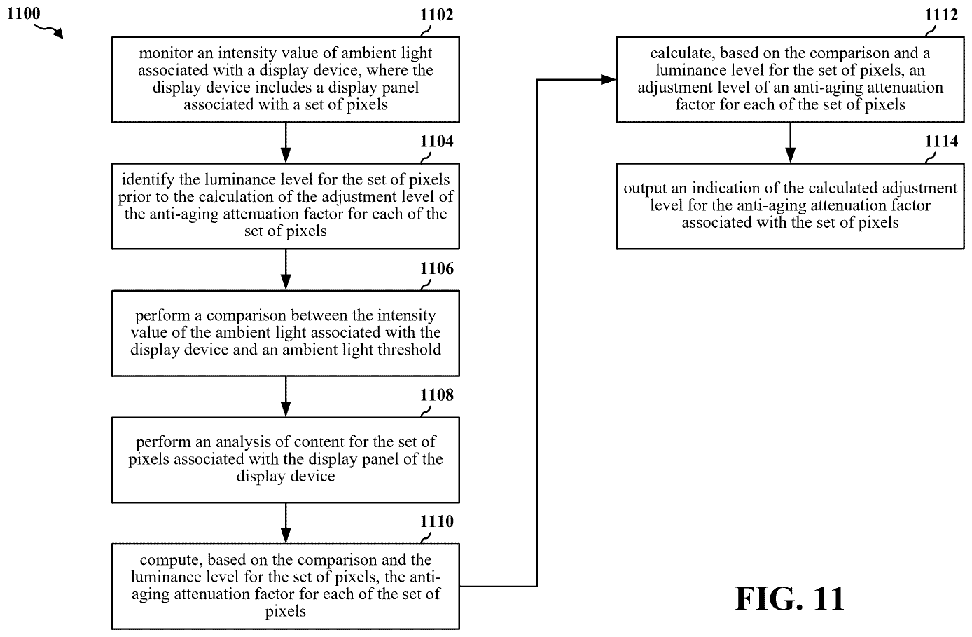

FIG. 11 is a flowchart 1100 of an example method of display processing in accordance with one or more techniques of this disclosure. The method may be performed by an apparatus, such as an apparatus for display processing, a GPU, a CPU, a wireless communication device, and the like, as used in connection with the aspects of FIGS. 1-9. In an example, the apparatus may be or include the device 104, the processing unit 120, the device 502, and/or the CPU 902. In an example, the method (including the various aspects detailed below) may be performed by the anti-aging compensator 198.

At 1102, the apparatus (e.g., a CPU) monitors an intensity value of ambient light associated with a display device, where the display device includes a display panel associated with a set of pixels. For example, FIG. 9 at 906 shows that the CPU 902 may monitor an intensity value of ambient light associated with a display device. In an example, the display device may be or include the device 104 and/or the device 502, the display panel may be or include the display(s) 131, the display panel 402, and/or the display panel 804, and the set of pixels may be or include the first pixel 404, the second pixel 406, the third pixel 408, the pixels 504, and/or the pixels 806. In another example, monitoring the intensity value of the ambient light may include aspects described above in connection with FIG. 5. In an example, 1102 may be performed by the anti-aging compensator 198.

At 1106, the apparatus (e.g., a CPU) performs a comparison between the intensity value of the ambient light associated with the display device and an ambient light threshold. For example, FIG. 9 at 910 shows that the CPU 902 may perform a comparison between the intensity value of the ambient light and an ambient light threshold. In an example, performing the comparison may include aspects described above in connection with FIG. 5 and/or the first example 602 of FIG. 6. In an example, 1106 may be performed by the anti-aging compensator 198.

At 1112, the apparatus (e.g., a CPU) calculates, based on the comparison and a luminance level for the set of pixels, an adjustment level of an anti-aging attenuation factor for each of the set of pixels. For example, FIG. 9 at 916 shows that the CPU 902 may compute an adjustment level of an anti-aging attenuation factor for a set of pixels based on the comparison performed at 910 and a luminance level for the set of pixels. In an example, calculating the adjustment level of the anti-aging attenuation factor for each of the set of pixels may include aspects described above in connection with FIGS. 5 and 6. In an example, 1112 may be performed by the anti-aging compensator 198.

At 1114, the apparatus (e.g., a CPU) outputs an indication of the calculated adjustment level for the anti-aging attenuation factor associated with the set of pixels. For example, FIG. 9 at 918 shows that the CPU 902 may output an indication of the calculated adjustment level for the anti-aging attenuation factor associated with the set of pixels. In an example, 1114 may be performed by the anti-aging compensator 198.

In one aspect, monitoring the intensity value of the ambient light associated with the display device may include: monitoring, via an ambient light sensor, the intensity value of the ambient light associated with the display device. For example, FIG. 9 at 906 shows that the CPU 902 may monitor the intensity value of the ambient light via an ambient light sensor. In an example, the ambient light sensor may be the ambient light sensor 506.

In one aspect, at 1104, the apparatus (e.g., a CPU) may identify the luminance level for the set of pixels prior to the calculation of the adjustment level of the anti-aging attenuation factor for each of the set of pixels, and calculating the adjustment level of the anti-aging attenuation factor for each of the set of pixels may include: calculating, based on the identified luminance level, the adjustment level of the anti-aging attenuation factor for each of the set of pixels. For example, FIG. 9 at 908 shows that the CPU 902 may identify a luminance level for the set of pixels prior to the calculation of the adjustment level of the anti-aging attenuation factor for each of the set of pixels at 916. Furthermore, FIG. 9 at 916 shows that calculation of the adjustment level of the anti-aging attenuation factor for each of the set of pixels may be based on the luminance level. In an example, 1104 may be performed by the anti-aging compensator 198.

In one aspect, at 1108, the apparatus (e.g., a CPU) may perform an analysis of content for the set of pixels associated with the display panel of the display device, and computing the anti-aging attenuation factor for each of the set of pixels may include: computing the anti-aging attenuation factor for each of the set of pixels based on the analysis of the content for the set of pixels. For example, FIG. 9 at 912 shows that the CPU 902 may perform an analysis of content for the set of pixels. Furthermore, FIG. 9 at 914 shows that computing the anti-aging attenuation factor for each of the set of pixels may be based on the analysis. In an example, performing the analysis may include aspects described above in connection with the third example 620 of FIG. 6. In an example, 1108 may be performed by the anti-aging compensator 198.

In one aspect, at 1110, the apparatus (e.g., a CPU) may compute, based on the comparison and the luminance level for the set of pixels, the anti-aging attenuation factor for each of the set of pixels, and calculating the adjustment level of the anti-aging attenuation factor for each of the set of pixels may include: calculating, based on the computed anti-aging attenuation factor, the adjustment level of the anti-aging attenuation factor for each of the set of pixels. For example, FIG. 9 at 914 shows that the CPU 902 may compute an anti-aging attenuation factor for each of the set of pixels based on the comparison performed at 910 and the luminance level identified at 908. Furthermore, FIG. 9 at 916 shows that the adjustment level of the anti-aging attenuation factor may be calculated based on the anti-aging attenuation factor computed at 914. In an example, 1110 may be performed by the anti-aging compensator 198.

In one aspect, calculating the adjustment level of the anti-aging attenuation factor for each of the set of pixels may include: setting the adjustment level of the anti-aging attenuation factor to a first level if the intensity value of the ambient light is less than the ambient light threshold. For example, FIG. 6 at 606 shows that the adjustment level of the anti-aging attenuation factor may be set to a first level if an intensity value of the ambient light is less than a first ambient light threshold.

In one aspect, calculating the adjustment level of the anti-aging attenuation factor for each of the set of pixels may include: setting the adjustment level of the anti-aging attenuation factor to a second level if the intensity value of the ambient light is greater than the ambient light threshold and less than a second ambient light threshold and if the luminance level is at or above a maximum luminance, where the second level is less than the first level. For example, FIG. 6 at 608 shows that the adjustment level of the anti-aging attenuation factor may be set to a second level if an intensity value of the ambient light is greater than a first ambient light threshold and less than a second ambient light threshold and if a luminance level equals a maximum luminance level.

In one aspect, the second level may be based on a pre-tuned value, a pre-tuned curve, or a distribution of values of the set of pixels for content that is displayed on the display panel. For example, the second value set at 608 in FIG. 6 may be a pre-tuned value. In another example, the second value may be associated with aspects described above in connection with the second example 612 and/or the third example 620 in FIG. 6.

In one aspect, calculating the adjustment level of the anti-aging attenuation factor for each of the set of pixels may include: setting the adjustment level of the anti-aging attenuation factor to a third level if the intensity value of the ambient light is greater than the second ambient light threshold and if the luminance level is at or above the maximum luminance, where the third level is less than the second level. For example, FIG. 6 at 610 shows that the adjustment level of the anti-aging attenuation factor may be set to a third level if an intensity value of the ambient light is greater than a second ambient light threshold and if a luminance level equals a maximum luminance level.

In one aspect, calculating the adjustment level of the anti-aging attenuation factor for each of the set of pixels may include: mapping the intensity value of the ambient light to the anti-aging attenuation factor for each of the set of pixels. For example, FIG. 9 at 916A shows that the CPU 902 may map an intensity value of ambient light to an anti-aging attenuation factor. In another example, mapping the intensity value of the ambient light to the anti-aging attenuation factor may include aspects described above in connection with FIGS. 5 and 6.

In one aspect, calculating the adjustment level of the anti-aging attenuation factor for each of the set of pixels may further include: calculating, based on the mapping, the adjustment level of the anti-aging attenuation factor for each of the set of pixels. For example, FIG. 9 at 916B shows that the CPU 902 may calculate an adjustment level of an anti-aging attenuation factor based on the mapping performed at 916A. In another example, calculating the adjustment level of the anti-aging attenuation factor for each of the set of pixels may include aspects described above in connection with FIGS. 5 and 6.

In one aspect, the mapping may correspond to a global strategy for the display panel of the display device or a layer-based strategy for the display panel of the display device. For instance, the first example 802 of FIG. 8 shows that the mapping may correspond to a global strategy and the second example 812 of FIG. 8 shows that the mapping may correspond to a layer-based strategy.

In one aspect, the layer-based strategy may correspond to a first adjustment level of the anti-aging attenuation factor for each of the set of pixels for a first layer in a set of layers associated with content that is displayed on the display panel, and the layer-based strategy may correspond to a second adjustment level of the anti-aging attenuation factor for each of the set of pixels for a second layer in the set of layers. For instance, the second example 812 of FIG. 8 shows that the first adjustment level of the anti-aging attenuation factor for each of the set of pixels for the first layer may correspond to the first pixels 808 and that the second adjustment level of the anti-aging attenuation factor for each of the set of pixels for the second layer may correspond to the second pixels 810.

In one aspect, outputting the indication of the calculated adjustment level for the anti-aging attenuation factor associated with the set of pixels may include: transmitting, to a display processing unit (DPU), the indication of the calculated adjustment level for the anti-aging attenuation factor associated with the set of pixels. For example, FIG. 9 at 918B shows that the CPU 902 may transmit an indication of the calculated adjustment level for the anti-aging attenuation factor associated with the set of pixels to the DPU 904. The DPU 904 may apply the calculated adjustment level for the anti-aging attenuation factor to the set of pixels such that the set of pixels have a desired luminance.

In one aspect, outputting the indication of the calculated adjustment level for the anti-aging attenuation factor associated with the set of pixels may include: storing, in a memory or a cache, the indication of the calculated adjustment level for the anti-aging attenuation factor associated with the set of pixels. For example, FIG. 9 at 918A shows that the CPU 902 may store, in memory or a cache, an indication of the calculated adjustment level for the anti-aging attenuation factor associated with the set of pixels.

In one aspect, the display panel may include an OLED display panel. For example, the display(s) 131, the display panel 402, and/or the display panel 804 may be or include OLEDs.

In configurations, a method or an apparatus for display processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for monitoring an intensity value of ambient light associated with a display device, where the display device includes a display panel associated with a set of pixels. The apparatus may further include means for performing a comparison between the intensity value of the ambient light associated with the display device and an ambient light threshold. The apparatus may further include means for calculating, based on the comparison and a luminance level for the set of pixels, an adjustment level of an anti-aging attenuation factor for each of the set of pixels. The apparatus may further include means for outputting an indication of the calculated adjustment level for the anti-aging attenuation factor associated with the set of pixels. The means for monitoring the intensity value of the ambient light associated with the display device may include means for monitoring, via an ambient light sensor, the intensity value of the ambient light associated with the display device. The apparatus may further include means for identifying the luminance level for the set of pixels prior to the calculation of the adjustment level of the anti-aging attenuation factor for each of the set of pixels and the means for calculating the adjustment level of the anti-aging attenuation factor for each of the set of pixels may include means for calculating, based on the identified luminance level, the adjustment level of the anti-aging attenuation factor for each of the set of pixels. The apparatus may further include means for computing, based on the comparison and the luminance level for the set of pixels, the anti-aging attenuation factor for each of the set of pixels and the means for calculating the adjustment level of the anti-aging attenuation factor for each of the set of pixels may include means for calculating, based on the computed anti-aging attenuation factor, the adjustment level of the anti-aging attenuation factor for each of the set of pixels. The apparatus may further include means for performing an analysis of content for the set of pixels associated with the display panel of the display device and the means for computing the anti-aging attenuation factor for each of the set of pixels may include means for computing the anti-aging attenuation factor for each of the set of pixels based on the analysis of the content for the set of pixels. The means for calculating the adjustment level of the anti-aging attenuation factor for each of the set of pixels may include means for setting the adjustment level of the anti-aging attenuation factor to a first level if the intensity value of the ambient light is less than the ambient light threshold. The means for calculating the adjustment level of the anti-aging attenuation factor for each of the set of pixels may include means for setting the adjustment level of the anti-aging attenuation factor to a second level if the intensity value of the ambient light is greater than the ambient light threshold and less than a second ambient light threshold and if the luminance level is at or above a maximum luminance, where the second level is less than the first level. The means for calculating the adjustment level of the anti-aging attenuation factor for each of the set of pixels may include means for setting the adjustment level of the anti-aging attenuation factor to a third level if the intensity value of the ambient light is greater than the second ambient light threshold and if the luminance level is at or above the maximum luminance, where the third level is less than the second level. The means for calculating the adjustment level of the anti-aging attenuation factor for each of the set of pixels may include means for mapping the intensity value of the ambient light to the anti-aging attenuation factor for each of the set of pixels and means for calculating, based on the mapping, the adjustment level of the anti-aging attenuation factor for each of the set of pixels. The means for outputting the indication of the calculated adjustment level for the anti-aging attenuation factor associated with the set of pixels may include means for transmitting, to a display processing unit (DPU), the indication of the calculated adjustment level for the anti-aging attenuation factor associated with the set of pixels. The means for outputting the indication of the calculated adjustment level for the anti-aging attenuation factor associated with the set of pixels may include means for storing, in a memory or a cache, the indication of the calculated adjustment level for the anti-aging attenuation factor associated with the set of pixels.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, including: monitoring an intensity value of ambient light associated with a display device, where the display device includes a display panel associated with a set of pixels; performing a comparison between the intensity value of the ambient light associated with the display device and an ambient light threshold; calculating, based on the comparison and a luminance level for the set of pixels, an adjustment level of an anti-aging attenuation factor for each of the set of pixels; and outputting an indication of the calculated adjustment level for the anti-aging attenuation factor associated with the set of pixels.

Aspect 2 may be combined with aspect 1 and includes that monitoring the intensity value of the ambient light associated with the display device includes: monitoring, via an ambient light sensor, the intensity value of the ambient light associated with the display device.

Aspect 3 may be combined with any of aspects 1-2 and further includes identifying the luminance level for the set of pixels prior to the calculation of the adjustment level of the anti-aging attenuation factor for each of the set of pixels, where calculating the adjustment level of the anti-aging attenuation factor for each of the set of pixels includes: calculating, based on the identified luminance level, the adjustment level of the anti-aging attenuation factor for each of the set of pixels.

Aspect 4 may be combined with aspect 3 and further includes computing, based on the comparison and the luminance level for the set of pixels, the anti-aging attenuation factor for each of the set of pixels, where calculating the adjustment level of the anti-aging attenuation factor for each of the set of pixels includes: calculating, based on the computed anti-aging attenuation factor, the adjustment level of the anti-aging attenuation factor for each of the set of pixels.

Aspect 5 may be combined with aspect 4 and further includes performing an analysis of content for the set of pixels associated with the display panel of the display device, where computing the anti-aging attenuation factor for each of the set of pixels includes: computing the anti-aging attenuation factor for each of the set of pixels based on the analysis of the content for the set of pixels.

Aspect 6 may be combined with aspects 1-5 and includes that calculating the adjustment level of the anti-aging attenuation factor for each of the set of pixels includes: setting the adjustment level of the anti-aging attenuation factor to a first level if the intensity value of the ambient light is less than the ambient light threshold.

Aspect 7 may be combined with aspect 6 and includes that calculating the adjustment level of the anti-aging attenuation factor for each of the set of pixels includes: setting the adjustment level of the anti-aging attenuation factor to a second level if the intensity value of the ambient light is greater than the ambient light threshold and less than a second ambient light threshold and if the luminance level is at or above a maximum luminance, where the second level is less than the first level.

Aspect 8 may be combined with aspect 7 and includes that the second level is based on a pre-tuned value, a pre-tuned curve, or a distribution of values of the set of pixels for content that is displayed on the display panel.

Aspect 9 may be combined with any of aspects 7-8 and includes that calculating the adjustment level of the anti-aging attenuation factor for each of the set of pixels includes: setting the adjustment level of the anti-aging attenuation factor to a third level if the intensity value of the ambient light is greater than the second ambient light threshold and if the luminance level is at or above the maximum luminance, where the third level is less than the second level.

Aspect 10 may be combined with any of aspects 1-5 and includes that calculating the adjustment level of the anti-aging attenuation factor for each of the set of pixels includes: mapping the intensity value of the ambient light to the anti-aging attenuation factor for each of the set of pixels; and calculating, based on the mapping, the adjustment level of the anti-aging attenuation factor for each of the set of pixels.

Aspect 11 may be combined with aspect 10 and includes that the mapping corresponds to a global strategy for the display panel of the display device or a layer-based strategy for the display panel of the display device.

Aspect 12 may be combined with aspect 11 and includes that the layer-based strategy corresponds to a first adjustment level of the anti-aging attenuation factor for each of the set of pixels for a first layer in a set of layers associated with content that is displayed on the display panel, and where the layer-based strategy corresponds to a second adjustment level of the anti-aging attenuation factor for each of the set of pixels for a second layer in the set of layers.

Aspect 13 may be combined with any of aspects 1-12 and includes that outputting the indication of the calculated adjustment level for the anti-aging attenuation factor associated with the set of pixels includes: transmitting, to a display processing unit (DPU), the indication of the calculated adjustment level for the anti-aging attenuation factor associated with the set of pixels.

Aspect 14 may be combined with any of aspects 1-13 and includes that outputting the indication of the calculated adjustment level for the anti-aging attenuation factor associated with the set of pixels includes: storing, in a memory or a cache, the indication of the calculated adjustment level for the anti-aging attenuation factor associated with the set of pixels.

Aspect 15 may be combined with any of aspects 1-14 and includes that the display panel includes an organic light-emitting diode (OLED) display panel.

Aspect 16 is an apparatus for display processing including at least one processor coupled to a memory and configured to implement a method as in any of aspects 1-15.

Aspect 17 may be combined with aspect 16 and includes that the apparatus is a wireless communication device including at least one of a transceiver or an antenna coupled to the at least one processor.

Aspect 18 is an apparatus for display processing including means for implementing a method as in any of aspects 1-15.

Aspect 19 is a computer-readable medium (e.g., a non-transitory computer-readable medium) storing computer executable code, the computer executable code when executed by at least one processor causes the at least one processor to implement a method as in any of aspects 1-15.

Various aspects have been described herein. These and other aspects are within the scope of the following claims.

1. An apparatus for display processing, comprising:
memory; and
at least one processor coupled to the memory and, based at least in part on information stored in the memory, the at least one processor is configured to:
monitor an intensity value of ambient light associated with a display device, wherein the display device includes a display panel associated with a set of pixels;
perform a comparison between the intensity value of the ambient light associated with the display device and an ambient light threshold;
calculate, based on the comparison and a luminance level for the set of pixels, an adjustment level of an anti-aging attenuation factor for each of the set of pixels; and
output an indication of the calculated adjustment level for the anti-aging attenuation factor associated with the set of pixels.

2. The apparatus of claim 1, wherein, to monitor the intensity value of the ambient light associated with the display device, the at least one processor is configured to:
monitor, via an ambient light sensor, the intensity value of the ambient light associated with the display device.

3. The apparatus of claim 1, wherein the at least one processor is further configured to:
identify the luminance level for the set of pixels prior to the calculation of the adjustment level of the anti-aging attenuation factor for each of the set of pixels, wherein, to calculate the adjustment level of the anti-aging attenuation factor for each of the set of pixels, the at least one processor is configured to:
calculate, based on the identified luminance level, the adjustment level of the anti-aging attenuation factor for each of the set of pixels.

4. The apparatus of claim 3, wherein the at least one processor is further configured to:
compute, based on the comparison and the luminance level for the set of pixels, the anti-aging attenuation factor for each of the set of pixels, wherein, to calculate the adjustment level of the anti-aging attenuation factor for each of the set of pixels, the at least one processor is configured to:
calculate, based on the computed anti-aging attenuation factor, the adjustment level of the anti-aging attenuation factor for each of the set of pixels.

5. The apparatus of claim 4, wherein the at least one processor is further configured to:
perform an analysis of content for the set of pixels associated with the display panel of the display device, wherein, to compute the anti-aging attenuation factor for each of the set of pixels, the at least one processor is configured to:
compute the anti-aging attenuation factor for each of the set of pixels based on the analysis of the content for the set of pixels.

6. The apparatus of claim 1, wherein, to calculate the adjustment level of the anti-aging attenuation factor for each of the set of pixels, the at least one processor is configured to:
set the adjustment level of the anti-aging attenuation factor to a first level if the intensity value of the ambient light is less than the ambient light threshold.

7. The apparatus of claim 6, wherein, to calculate the adjustment level of the anti-aging attenuation factor for each of the set of pixels, the at least one processor is configured to:
set the adjustment level of the anti-aging attenuation factor to a second level if the intensity value of the ambient light is greater than the ambient light threshold and less than a second ambient light threshold and if the luminance level is at or above a maximum luminance, wherein the second level is less than the first level.

8. The apparatus of claim 7, wherein the second level is based on a pre-tuned value, a pre-tuned curve, or a distribution of values of the set of pixels for content that is displayed on the display panel.

9. The apparatus of claim 7, wherein, to calculate the adjustment level of the anti-aging attenuation factor for each of the set of pixels, the at least one processor is configured to:
set the adjustment level of the anti-aging attenuation factor to a third level if the intensity value of the ambient light is greater than the second ambient light threshold and if the luminance level is at or above the maximum luminance, wherein the third level is less than the second level.

10. The apparatus of claim 1, wherein, to calculate the adjustment level of the anti-aging attenuation factor for each of the set of pixels, the at least one processor is configured to:
map the intensity value of the ambient light to the anti-aging attenuation factor for each of the set of pixels; and
calculate, based on the mapping, the adjustment level of the anti-aging attenuation factor for each of the set of pixels.

11. The apparatus of claim 10, wherein the mapping corresponds to a global strategy for the display panel of the display device or a layer-based strategy for the display panel of the display device.

12. The apparatus of claim 11, wherein the layer-based strategy corresponds to a first adjustment level of the anti-aging attenuation factor for each of the set of pixels for a first layer in a set of layers associated with content that is displayed on the display panel, and wherein the layer-based strategy corresponds to a second adjustment level of the anti-aging attenuation factor for each of the set of pixels for a second layer in the set of layers.

13. The apparatus of claim 1, wherein, to output the indication of the calculated adjustment level for the anti-aging attenuation factor associated with the set of pixels, the at least one processor is configured to:
transmit, to a display processing unit (DPU), the indication of the calculated adjustment level for the anti-aging attenuation factor associated with the set of pixels.

14. The apparatus of claim 1, wherein, to output the indication of the calculated adjustment level for the anti-aging attenuation factor associated with the set of pixels, the at least one processor is configured to:
store, in the memory or a cache, the indication of the calculated adjustment level for the anti-aging attenuation factor associated with the set of pixels.

15. The apparatus of claim 1, wherein the display panel comprises an organic light-emitting diode (OLED) display panel.

16. The apparatus of claim 1, wherein the apparatus comprises a wireless communication device comprising at least one of a transceiver or an antenna coupled to the at least one processor.

17. A method of display processing, comprising:
monitoring an intensity value of ambient light associated with a display device, wherein the display device includes a display panel associated with a set of pixels;
performing a comparison between the intensity value of the ambient light associated with the display device and an ambient light threshold;
calculating, based on the comparison and a luminance level for the set of pixels, an adjustment level of an anti-aging attenuation factor for each of the set of pixels; and
outputting an indication of the calculated adjustment level for the anti-aging attenuation factor associated with the set of pixels.

18. (canceled)

19. The method of claim 17, further comprising:
identifying the luminance level for the set of pixels prior to the calculation of the adjustment level of the anti-aging attenuation factor for each of the set of pixels, wherein calculating the adjustment level of the anti-aging attenuation factor for each of the set of pixels comprises: calculating, based on the identified luminance level, the adjustment level of the anti-aging attenuation factor for each of the set of pixels;
computing, based on the comparison and the luminance level for the set of pixels, the anti-aging attenuation factor for each of the set of pixels, wherein calculating the adjustment level of the anti-aging attenuation factor for each of the set of pixels comprises: calculating, based on the computed anti-aging attenuation factor, the adjustment level of the anti-aging attenuation factor for each of the set of pixels; and
performing an analysis of content for the set of pixels associated with the display panel of the display device, wherein computing the anti-aging attenuation factor for each of the set of pixels comprises: computing the anti-aging attenuation factor for each of the set of pixels based on the analysis of the content for the set of pixels.

20.-25. (canceled)

26. The method of claim 17, wherein calculating the adjustment level of the anti-aging attenuation factor for each of the set of pixels comprises:
mapping the intensity value of the ambient light to the anti-aging attenuation factor for each of the set of pixels, wherein the mapping corresponds to a global strategy for the display panel of the display device or a layer-based strategy for the display panel of the display device; and
calculating, based on the mapping, the adjustment level of the anti-aging attenuation factor for each of the set of pixels, wherein the layer-based strategy corresponds to a first adjustment level of the anti-aging attenuation factor for each of the set of pixels for a first layer in a set of layers associated with content that is displayed on the display panel, and wherein the layer-based strategy corresponds to a second adjustment level of the anti-aging attenuation factor for each of the set of pixels for a second layer in the set of layers.

27.-29. (canceled)

30. A computer-readable medium storing computer executable code, the computer executable code when executed by at least one processor causes the at least one processor to:
monitor an intensity value of ambient light associated with a display device, wherein the display device includes a display panel associated with a set of pixels;
perform a comparison between the intensity value of the ambient light associated with the display device and an ambient light threshold;
calculate, based on the comparison and a luminance level for the set of pixels, an adjustment level of an anti-aging attenuation factor for each of the set of pixels; and
output an indication of the calculated adjustment level for the anti-aging attenuation factor associated with the set of pixels.
